(19) United States
(12) Patent Application Publication
(10) Pub. No.: US 2021/0159506 A1
(43) Pub. Date: May 27, 2021

(54) COMPOSITE MICROSTRUCTURED CURRENT COLLECTOR FOR LITHIUM ION BATTERY AND FABRICATING METHOD THEREFOR

(71) Applicant: SOUTH CHINA UNIVERSITY OF TECHNOLOGY, Guangdong (CN)

(72) Inventors: Wei YUAN, Guangdong (CN); Zhiqiang QIU, Guangdong (CN); Baoyou PAN, Guangdong (CN); Jian LUO, Guangdong (CN); Shimin HUANG, Guangdong (CN); Yong TANG, Guangdong (CN)

(73) Assignee: SOUTH CHINA UNIVERSITY OF TECHNOLOGY, Guangdong (CN)

(21) Appl. No.: 17/046,803

(22) PCT Filed: Oct. 31, 2018
(86) PCT No.: PCT/CN2018/113218

§ 371 Date: Oct. 12, 2020

(30) Foreign Application Priority Data
Apr. 13, 2018 (CN) 201810329828.X

(51) Int. Cl. H01M 4/66; H01M 10/0525; H01M 4/72

(52) U.S. Cl. CPC H01M 4/661; H01M 4/72; H01M 10/0525

(57) ABSTRACT

Disclosed are a composite microstructured current collector for a lithium ion battery and a fabricating method therefor. The composite microstructured current collector comprises a smooth bottom surface (9) and a top surface with a composite microstructure. The top surface comprises micro protrusions (10) and grooves (11), and the micro protrusions (10) are surrounded by the grooves (11). The micro protrusions (10) are provided with concave holes, scaly burrs, and sunken structures. The fabricating method comprises the following steps: (1) design of a cutter and pretreatment of a copper sheet; and (2) processing of a surface microstructure by plowing.

### BACKGROUND

### Technical Field

The present invention relates to the technical field of lithium ion batteries, and more particularly, to a composite microstructured current collector for a lithium ion battery and a fabricating method therefor.

### Description of Related Art

Compared with valve-regulated lead-acid batteries, rechargeable nickel-cadmium batteries or nickel-hydrogen batteries, lithium ion batteries have become the best among these secondary batteries due to advantages of a high unit energy density, a wide application range and an excellent high-current discharge performance thereof although the lithium ion batteries have been published for less than 30 years. At the beginning of the new century, with the research and development of new energy power vehicles, energy reform aiming at reducing the environmental pollution caused by energy consumption and replacing an old energy structure based on fossil fuels is advancing, and an energy structure taking the lithium ion battery as a core is gaining wide recognition and acceptance.

A current collector of the lithium ion battery shall have the advantages of a light weight, a high mechanical strength, a large surface area, a good electrochemical stability in an electrolyte and a good contact with an active material. At present, commercial copper foil current collectors refer to electrolytic copper foils with double smooth surfaces, single rough surface or double rough surfaces, the surface structures of which are excessively single. Active materials are directly coated on the current collector without a special surface structure, and the active materials are mechanically bonded with the current collector only, which results in the defects of a low bonding strength and a small effective bonding area, leading to an excessively large contact resistance between the active material and the current collector, and further causing problems of a low reversible capacity, a poor rate performance and a poor capacity stability of the battery, so as to affect overall performances of the battery.

In order to improve the performances of the lithium ion battery, some scholars use a template method to fabricate a three-dimensional porous copper foil current collector or use flexible carbon paper and high-efficiency conductive paper instead of the copper foil current collector. These materials and methods for fabricating the current collector need further study. In order to improve the bonding strength between the active material and the current collector and an electric conductivity of an electrode, it is of great significance to study a current collector with a special surface functional structure and a key fabricating technology and method therefor, so that interfaces closely engaged with each other are formed between the current collector and active material particles, thus reducing the contact resistance between the active material and the current collector and reducing capacity attenuation caused by a volume change of the active material.

### SUMMARY

In order to improve a bonding strength between a current collector and an active material, reduce a contact resistance between the current collector and the active material, and improve an electric conductivity of an electrode, so as to improve charge and discharge capacity and stability of a lithium ion battery, an objective of the present invention is to provide a composite microstructured current collector for a lithium ion battery and a fabricating method therefor. The composite microstructured copper current collector has a composite microstructure of grooves, concave holes, scaly burrs, sunken structures and the like. The concave holes, the scaly burrs and the sunken structures are located on micro protrusions of a top surface of the current collector; and the micro protrusions are surrounded by the grooves.

The objective of the present invention is achieved by the following technical solutions.

According to a composite microstructured current collector for a lithium ion battery, the composite microstructured current collector comprises a smooth bottom surface 9 and a top surface with a composite microstructure; the top surface comprises micro protrusions 10 and grooves 11, and the micro protrusions 10 are surrounded by the grooves 11; and the micro protrusions 10 are provided with concave holes, scaly burrs, and sunken structures.

A method for fabricating the above composite microstructured current collector for the lithium ion battery comprises the following steps: (1) design of a plowing cutter and pretreatment of a copper sheet; and (2) processing of a surface microstructure of a copper current collector by plowing.

Preferably, the design of the plowing cutter and the pretreatment of the copper sheet comprise the following steps:

(1) the design of the plowing cutter: a front angle α of the plowing cutter is 40° to 50°, a rear angle κ of the plowing cutter is 20° to 30°, an extruded cutting edge inclination β is 15° to 30°, a forming angle θ is 10° to 20°, a width B₀ of the plowing cutter is 10 mm to 20 mm and a thickness Lₜ of the plowing cutter is 2 mm to 4 mm; and

(2) the pretreatment of the copper sheet: polishing the copper sheet with sandpaper to make two surfaces of the copper sheet flat, then soaking and continuously stirring the copper sheet in a copper-clad plate surface cleaning agent to make the two surfaces of the copper sheet smooth.

Further preferably, the plowing cutter is made of W18Cr4V.

Further preferably, the copper sheet is round.

Further preferably, a thickness of the copper sheet is 0.5 mm to 1 mm.

Further preferably, the soaking and the continuously stirring last for 3 minutes to 5 minutes.

Preferably, the processing of the surface microstructure of the copper current collector by plowing comprises the following steps:

(1) cutter clamping and workpiece fixing: clamping the plowing cutter on a planer, adhering the copper sheet to a stainless steel square platform with a metal 502 glue, then fixing the square platform on a vice of the planer, and then correcting a vertical direction of the cutter and the surface of the copper sheet with a dial indicator;

(2) adjustment of working parameters of the planer: setting a working stroke of the planer, so that the working stroke of the cutter covers an outline of the copper sheet, and then setting the cutter;

(3) first plowing-extrusion: adjusting a cutting depth to be 100 μm to 150 μm, and a workpiece feeding amount to be 250 μm to 400 μm, starting first plowing at an edge of the copper sheet, and forming an array groove structure on the surface of the copper sheet;

(4) second plowing-extrusion: rotating the square platform, correcting a plane of the copper sheet with the dial indicator again, and performing second plowing-extrusion by using the cutting depth and the feeding amount in step (3) after setting the cutter, wherein the second plowing-extrusion not only cuts on a substrate of the copper sheet, but also performs vertical second plowing-extrusion on the grooves formed by the first plowing-extrusion; and finally obtaining a composite microstructure of grooves, concave holes, scaly burrs, sunken structures and the like; and

(5) treatment of plowed workpiece: disassembling the plowed workpiece from the square platform, putting the square platform into a blast drying oven for heating, then cooling the square platform to a room temperature, so that the glue is failed, then taking out the processed copper sheet, and cleaning the copper sheet with alcohol to obtain the composite microstructured current collector.

Further preferably, an angle of the rotation in step (4) is 90°.

Further preferably, a temperature of the heating in step (5) is 100° C. to 120° C., and the heating lasts for 10 minutes to 15 minutes. More preferably, the temperature of the heating is 100° C., and the heating lasts for 10 minutes.

Compared with the prior art, the present invention has the following advantages.

(1) The composite microstructure of grooves, concave holes, scaly burrs, sunken structures and the like on the surface of the composite microstructured current collector of the present invention may provide a volume change buffer space for the active material and enhance a bonding force between the active material and the current collector, thus improving a reversible capacity and a capacity stability of the battery.

(2) The structure of the composite microstructured current collector of the present invention may increase a contact surface area between the current collector and the active material, increase a loading capacity of the active material, improve an electric conductivity of the electrode, and reduce a battery impedance, thus achieving the purposes of increasing a capacity and improving a rate performance.

(3) The current collector with the composite microstructure is processed by a facile mechanical processing method of plowing in the present invention, which has the features of simple processing, low cost, environmental friendliness and the like compared with other chemical processing methods.

### BRIEF DESCRIPTION OF THE DRAWINGS

FIG. 1 is a macro structure diagram of a composite microstructured current collector;

FIG. 2 is a real product diagram of the composite microstructured current collector;

FIG. 3 is a scanning electron microscope diagram of the composite microstructured current collector;

FIG. 4 is a schematic diagram illustrating parameters of a processing cutter of the composite microstructure;

FIG. 5 is a schematic diagram illustrating a processing course of the composite microstructure;

FIG. 6 is an assembly diagram of a lithium ion half-battery provided with the composite microstructured current collector;

FIG. 7 is a curve graph of cyclic charge and discharge tests of the lithium ion half-battery provided with the composite microstructured current collector and a lithium ion half-battery provided with a structureless current collector;

FIG. 8 is a curve graph of rate charge and discharge tests of the lithium ion half-battery provided with the composite microstructured current collector and the lithium ion half-battery provided with the structureless current collector; and

FIG. 9 is a curve graph of AC impedance tests of the lithium ion half-battery provided with the composite microstructured current collector and the lithium ion half-battery provided with the structureless current collector.

### DESCRIPTION OF THE EMBODIMENTS

In order to further understand the present invention, the present invention is further described with reference to the accompanying drawings and the embodiments, but it should be noted that the scope sought to be protected by the present invention is not limited to the scope expressed by the embodiments.

### Embodiment 1

A composite microstructured current collector for a lithium ion battery and a fabricating method therefor are provided, and the method comprises the followings steps.

(1) Design of a cutter: the cutter is made of W18Cr4V. Main angles of the cutter comprise that: a front angle α is 40°, a rear angle κ is 20°, an extruded cutting edge inclination β is 30°, and a forming angle θ is 20°. Other parameters of the cutter comprise that: a width B₀ of the cutter is 20 mm and a thickness Lₜ of the cutter is 4 mm (see FIG. 4).

(2) Surface pretreatment of a round copper sheet: a copper sheet with a thickness of 0.5 mm is polished with sandpaper to make two surfaces of the copper sheet flat, and then the copper sheet is soaked and continuously stirred for 5 minutes in a copper-clad plate surface cleaning agent to make the two surfaces of the copper sheet smooth.

(3) Cutter clamping and workpiece fixing: the plowing cutter is clamped on a planer, the round copper sheet is adhered to a stainless steel square platform with a metal 502 glue, then the square platform is fixed on a vice of the planer, and then a vertical direction of the cutter and the surface of the round copper sheet are corrected with a dial indicator.

(4) Adjustment of working parameters of the planer: a working stroke of the planer is set, so that the working stroke of the cutter covers an outline of the copper sheet, and then the cutter is set.

(5) First plowing-extrusion: a cutting depth is adjusted to be 150 μm, and a workpiece feeding amount is adjusted to be 250 μm. First plowing is started at an edge of the copper sheet, and an array groove structure is formed on the surface of the copper sheet.

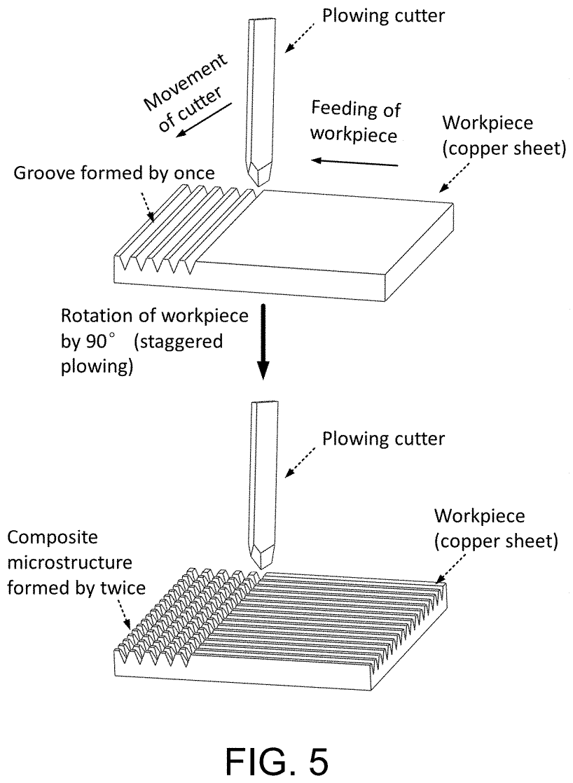

(6) Second plowing-extrusion: the square platform is rotated by 90°, a plane of an aluminium plate is corrected with the dial indicator again, and second plowing-extrusion is performed by using the same cutting depth and feeding amount after setting the cutter. The second plowing-extrusion not only cuts on a substrate of the copper sheet, but also performs vertical second plowing-extrusion on the grooves formed by the first plowing-extrusion. A composite microstructure of grooves, concave holes, scaly burrs, sunken structures and the like is finally obtained. A fabricating process is shown in FIG. 5.

(7) Treatment of plowed workpiece: the plowed workpiece is disassembled from the square platform, the square platform is put into a blast drying oven for heating at 100° C. for 10 minutes, then the square platform is cooled to a room temperature, so that the glue is failed, then the processed round copper sheet is taken out and cleaned with alcohol to obtain the composite microstructured current collector.

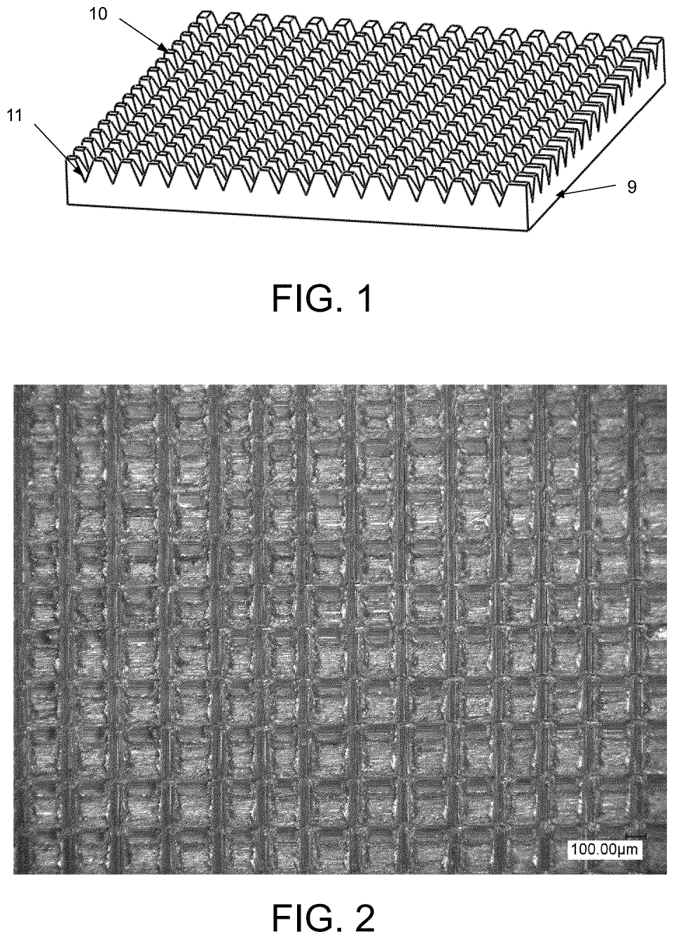

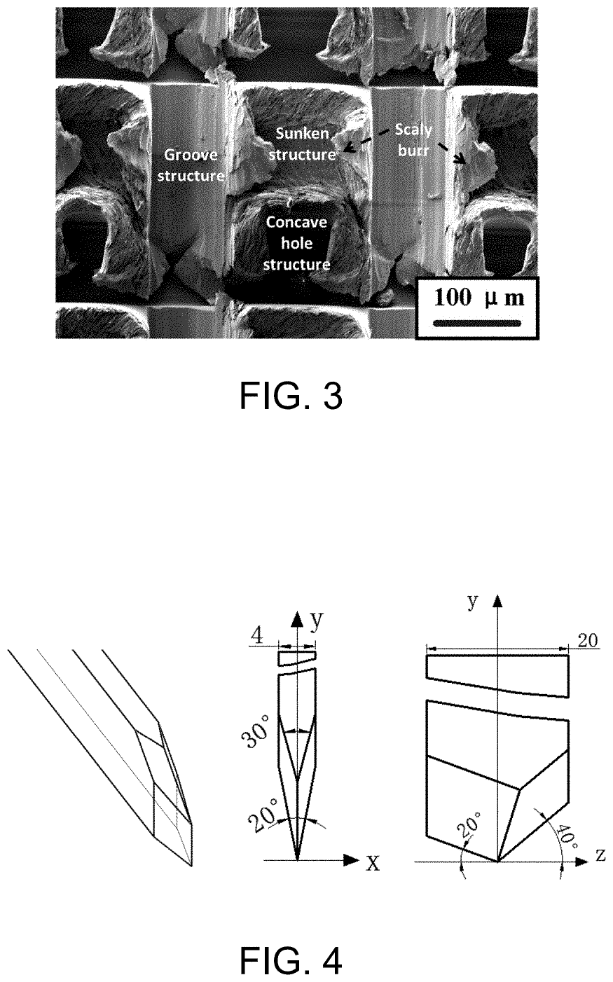

The composite microstructure copper current collector obtained in the embodiment comprises a smooth bottom surface 9 and a top surface with a composite microstructure. The top surface comprises micro protrusions 10 and grooves 11, and the micro protrusions 10 are surrounded by the grooves 11. The micro protrusions 10 are provided with concave holes, scaly burrs, and sunken structures. A macro structure diagram is shown in FIG. 1, a real product diagram is shown in FIG. 2, and a scanning electron microscope diagram of the composite microstructure is shown in FIG. 3.

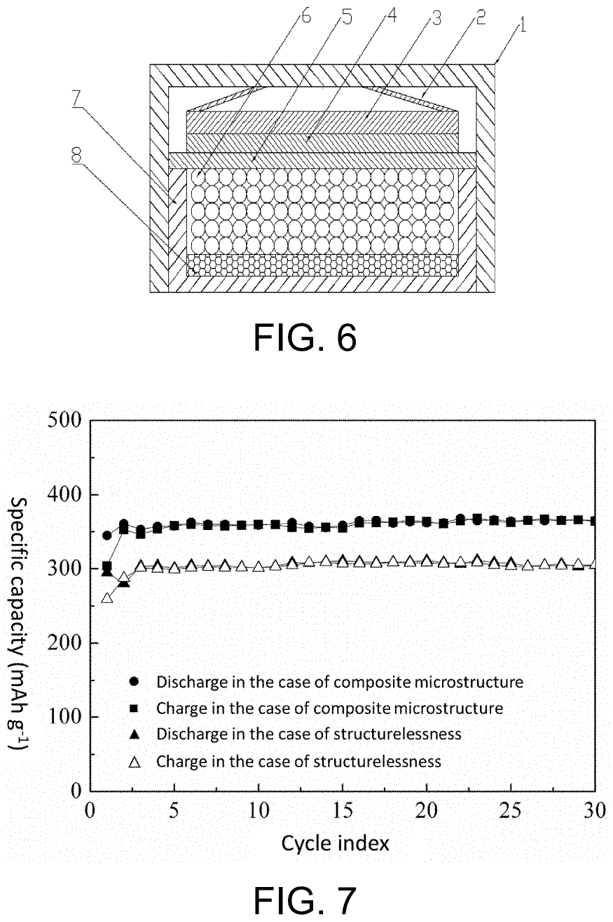

As shown in FIG. 6, the composite microstructured current collector obtained in the embodiment is made into an electrode sheet 8 and then placed on a lower battery case 7. An electrolyte 6 directly infiltrates an active material on the electrode sheet 8, and the electrolyte 6 fills a whole cavity formed by the electrode sheet 8, the lower battery case 7 and a diaphragm 5. A lithium sheet 4 is closely attached to the diaphragm 5, a gasket 3 and an elastic piece 2 are sequentially placed on an upper surface of the lithium sheet 4 from bottom to top, and the gasket 3 and the elastic piece 2 play a role of pressure adjustment. The elastic piece 2 is in close contact with an upper battery case 1 to reduce a contact resistance, so as to ensure a good electric conductivity inside a battery. After the electrode sheet 8 is assembled into a lithium ion half-battery as shown in FIG. 2, when the lithium ion half-battery is discharged, the lithium sheet 4 starts to delithiate, and lithium ions enter into the electrolyte 6 through the diaphragm 5, and then contact with the active material on the electrode sheet 8 to generate a lithium intercalation reaction. Meanwhile, electrons enter the lower battery case 7 through the gasket 3, the elastic piece 2 and the upper battery case 1 in sequence. Since the lower battery case 7 is in close contact with the electrode sheet 8, the electrons then enter the active material on the electrode sheet 8 to perform charge neutralization with the lithium ions, thus completing a discharging process of the lithium ion half-battery. When the lithium ion half-battery shown is charged, the lithium ions are first de-intercalated from the active material on the electrode 8 and enter into the electrolyte 6, and then contact with the lithium sheet 4 through the diaphragm 5. The electrons are transferred from the active material on the electrode sheet 8, and pass through the lower battery case 7, the upper battery case 1, the elastic piece 2 and the gasket 3 in sequence to perform charge balance with the lithium ions on the lithium sheet 4, thus completing a charging process. In the charging and discharging processes of the lithium ion half-battery, since the composite microstructure of grooves, concave holes, scaly burrs, sunken structures and the like on the surface of the copper current collector may provide a volume change buffer space for the active material and enhance a bonding force between the active material and the current collector, a reversible capacity and a capacity stability of the battery are improved. Meanwhile, the composite microstructure increases a contact surface area between the copper current collector and the active material, increases a loading capacity of the active material, improves an electric conductivity of the electrode, and reduces a battery impedance, thus achieving the purposes of increasing a capacity and improving a rate performance.

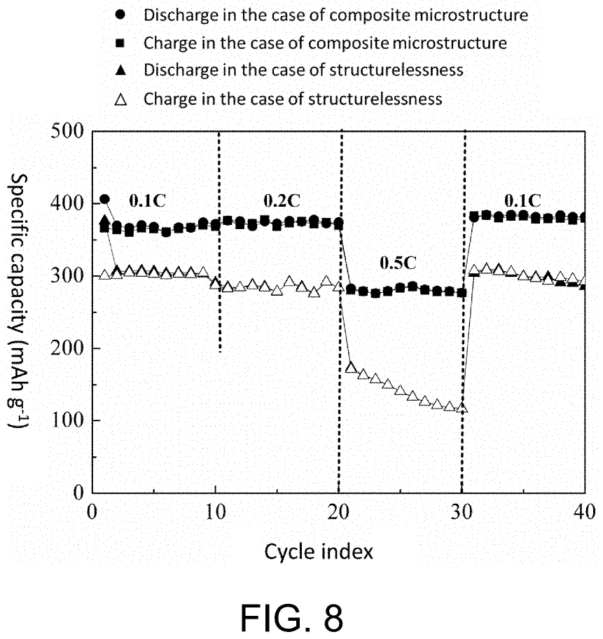

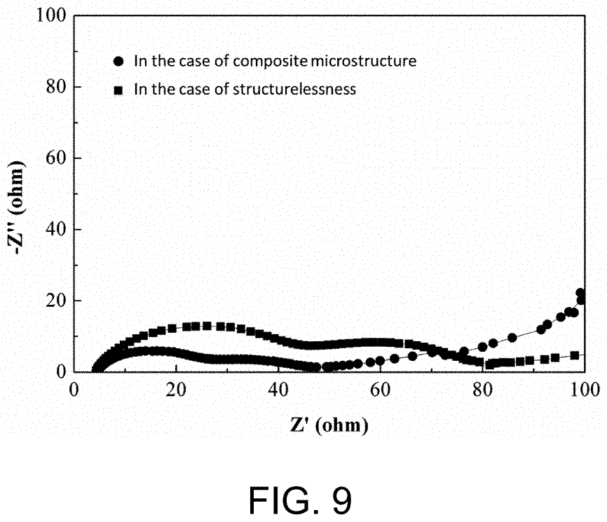

The copper current collector for the lithium ion battery provided in the embodiment constitutes the lithium ion half-battery, and a LAND battery test system CT2001A is used to conduct cyclic charge and discharge tests on the lithium ion half-battery. The obtained test curve is shown in FIG. 7. It can be seen from the figure that a lithium ion battery with the composite microstructure copper current collector has an initial discharge capacity of 345.0 mAh g⁻¹ and a stable capacity as high as 364.9 mAh g⁻¹, while a lithium ion battery with a structureless current collector has an initial discharge capacity of 294.6 mAh g⁻¹ and a stable capacity of 304.7 mAh g⁻¹. Tested rate performances are shown in FIG. 8. It can be seen from the figure that the stable capacities of the lithium ion battery with the composite microstructure copper current collector are 372 mAh g⁻¹, 374.3 mAh g⁻¹, 276.9 mAh g⁻¹ and 379.8 mAh g⁻¹ in sequence at rates of 0.1 C, 0.2 C, 0.5 C and 0.1 C, while the stable capacities of the lithium ion battery with the structureless current collector are 287.2 mAh g⁻¹, 284 mAh g⁻¹, 116.6 mAh g⁻¹ and 292.8 mAh g⁻¹ in sequence at rates of 0.1 C, 0.2 C, 0.5 C and 0.1 C. It can be seen that capacity retention rates of the lithium ion battery with the composite microstructure copper current collector at 0.2 C and 0.5 C are 100.61% and 74.43% in comparision to the battery without rate charge and discharge, while capacity retention rates of the lithium ion battery with the structureless current collector at 0.2 C and 0.5 C are 98.89% and 40.60% in comparision to the battery without rate charge and discharge. AC impedance tests are shown in FIG. 9. It is obvious that an impedance of the lithium ion battery with the composite microstructure copper current collector is relatively small.

The above embodiments of the present invention are only examples for clearly explaining the present invention, and are not intended to limit the implementation modes of the present invention. Other changes or variations in different forms may be made on the basis of the above description for those of ordinary skill in the art. All embodiments need not and cannot be exhaustive here. Any modification, equivalent substitution, improvement, etc. made within the spirit and principle of the present invention shall be included in the scope of protection of the claims of the present invention.

1. A composite microstructured current collector for a lithium ion battery, wherein the composite microstructured current collector comprises a smooth bottom surface (9) and a top surface with a composite microstructure; the top surface comprises micro protrusions (10) and grooves (11), and the micro protrusions (10) are surrounded by the grooves (11); and the micro protrusions (10) are provided with concave holes, scaly burrs, and sunken structures.

2. A method for fabricating the composite microstructured current collector for the lithium ion battery according to claim 1, wherein the method comprises the following steps: (1) design of a plowing cutter and pretreatment of a copper sheet; and (2) processing of a surface microstructure of a copper current collector by plowing.

3. The fabricating method according to claim 2, wherein the design of the plowing cutter and the pretreatment of the copper sheet comprise the following steps:
(1) the design of the plowing cutter: a front angle α of the plowing cutter is 40° to 50°, a rear angle κ of the plowing cutter is 20° to 30°, an extruded cutting edge inclination β is 15° to 30°, a forming angle θ is 10° to 20°, a width B₀ of the plowing cutter is 10 mm to 20 mm and a thickness Lₜ of the plowing cutter is 2 mm to 4 mm; and
(2) the pretreatment of the copper sheet: polishing the copper sheet with sandpaper to make two surfaces of the copper sheet flat, then soaking and continuously stirring the copper sheet in a copper-clad plate surface cleaning agent to make the two surfaces of the copper sheet smooth.

4. The fabricating method according to claim 3, wherein the plowing cutter is made of W18Cr4V.

5. The fabricating method according to claim 3, wherein the copper sheet is round.

6. The fabricating method according to claim 3, wherein a thickness of the copper sheet is 0.5 mm to 1 mm.

7. The fabricating method according to claim 3, wherein the soaking and the continuously stirring last for 3 minutes to 5 minutes.

8. The fabricating method according to claim 2, wherein the processing of the surface microstructure of the copper current collector by plowing comprises the following steps:
(1) cutter clamping and workpiece fixing: clamping the plowing cutter on a planer, adhering the copper sheet to a stainless steel square platform with a metal 502 glue, then fixing the square platform on a vice of the planer, and then correcting a vertical direction of the cutter and the surface of the copper sheet with a dial indicator;
(2) adjustment of working parameters of the planer: setting a working stroke of the planer, so that the working stroke of the plowing cutter covers an outline of the copper sheet, and then setting the cutter;
(3) first plowing-extrusion: adjusting a cutting depth to be 100 μm to 150 μm, and a workpiece feeding amount to be 250 μm to 400 μm, starting first plowing at an edge of the copper sheet, and forming an array groove structure on the surface of the copper sheet;
(4) second plowing-extrusion: rotating the square platform, correcting a plane of the copper sheet with the dial indicator again, and performing second plowing-extrusion by using the cutting depth and the feeding amount in step (3) after setting the cutter, wherein the second plowing-extrusion not only cuts on a substrate of the copper sheet, but also performs vertical second plowing-extrusion on grooves formed by the first plowing-extrusion; and finally obtaining a composite microstructure of grooves, concave holes, scaly burrs, and sunken structures; and
(5) treatment of plowed workpiece: disassembling the plowed workpiece from the square platform, putting the square platform into a blast drying oven for heating, then cooling the square platform to a room temperature, so that the glue is failed, then taking out the processed copper sheet, and cleaning the copper sheet with alcohol to obtain the composite microstructured current collector.

9. The fabricating method according to claim 8, wherein an angle of the rotation in step (4) is 90°.

10. The fabricating method according to claim 8, wherein a temperature of the heating in step (5) is 100° C. to 120° C., and the heating lasts for 10 minutes to 15 minutes.
